(19) United States
(12) Patent Application Publication
(10) Pub. No.: US 2008/0179142 A1
(43) Pub. Date: Jul. 31, 2008

(54) Torque Motor Type Elevator

(76) Inventors: Yung-Tsai CHUO, Taichung (TW); Yi-Cheng Su, Taichung (TW)

Correspondence Address: Dr. BANGER SHIA, 102 Lindencrest Ct., Sugar Land, TX, 77479-5201, US

(21) Appl. No.: 11/627,960

(22) Filed: Jan. 27, 2007

(51) Int. Cl. B66B 9/02

(52) U.S. Cl. 187/250; 187/268

(57) ABSTRACT

A torque motor type elevator comprises a torque motor, a ball screw, a sliding nut and an elevator car. The torque motor serves to drive the load screw of the ball screw directly, so the elevator car fixed to the load nut is moved up and down. The ball screw of the present invention is provided for reducing the loss of energy of the elevator driving system, and the sliding nut is disposed on the ball screw to improve its safety. The torque motor can be added with a resolver or an encoder to control the position precisely. Such arrangements can prevent the problem of energy consumption and can simplify the structure.

### BACKGROUND OF THE INVENTION

1. Field of the Invention

The present invention relates to an elevator, and more particularly to a torque motor type elevator that comprises a torque motor, a ball screw, a sliding nut and an elevator car, which is easy in structure and can save energy.

2. Description of the Prior Art

An elevator is indispensable equipment in human's daily life, in addition to carrying persons and goods, the elevator also has the properties of easy to control, high safety and durable. Therefore, as far as the modern building is concerned, the elevator is very important.

Existing elevator drive system generally includes screw drive system, oil pressure drive system, steel cable type drive system and linear motor drive system.

Nowadays, the more often used drive system is the steel cable type drive system to drive an elevator car to move up and down, and the power source of the common steel cable type drive system is originated from an induction motor. Referring to FIG. 1, a conventional steel cable type elevator comprises an induction motor 10, a decelerating box 11, a reel 12, a steel cable 13, a counterweight 14 and an elevator car 15. The induction motor 10 cooperates with the decelerating box 11 to drive the reel 12, and the fastening and releasing of the reel 12 serves to adjust the up and down motion of the counterweight 14 and the elevator car 15, however, the conventional steel cable type elevator has the following disadvantages:

Firstly, such an steel cable type elevator must comprises the induction motor 10, the decelerating box 11, the reel 12, the steel cable 13 and the counterweight 14, so the conventional steel cable type elevator is complicated in structure and occupies a lot of building space.

Secondly, the steel cable type elevator is likely to be shaken and has big noise, and must be maintained regularly, or else, an accident is liable to occur.

Thirdly, a controlling system 16, an induction system 17 and a power system of the steel cable type elevator belong to different systems, so the position of the elevator cannot be controlled by the induction motor 10 directly. Thereby, the conventional steel cable type elevator is hard to control precisely and is susceptible to the control problem and induction failure.

The screw drive system has been used on elevator for almost one hundred years, wherein an induction motor cooperates with a decelerating box to drive a screw, and a lifting member screwed on the screw serves to drive an elevator car. Such arrangements can simplify the structure as compared to the steel cable type elevator, and the method of driving the elevator car to move up and down by using rotating sliding friction of the screw and the lifting member is very safe. However, the conventional screw drive system for an elevator still has the following disadvantages:

Firstly, since the screw and the lifting member of the conventional screw drive system for an elevator use rotating sliding friction to drive the elevator car to move up and down, the friction resistance is great and the mechanical efficiency is as low as 30%. Therefore, it is uneconomic in terms of power consumption.

Secondly, with the increase of the height of the building, the elevator is required to move fast, therefore, the high friction resistance will result in a high temperature of the screw drive system.

Thirdly, the induction motor is not easy to control, and the control and induction system and the driving system of the induction motor belong to different systems, so the position of the elevator cannot be controlled by the induction motor directly. Thereby, the conventional screw drive system for an elevator is hard to control precisely and is susceptible to the control problem and induction failure.

To overcome the above-mentioned shortcomings, in recent years, ball screw was used on the elevator to replace the conventional screw drive system. The advantage of the ball screw is that it has very low friction resistance and high mechanical efficiency. However, the ball screw drive system still has some disadvantages:

Firstly, the conventional elevators are driven by the induction motor and the decelerating box, since the torque value of such an induction motor is not ideal, the induction motor must use a decelerating box to control the elevator. Thereby, the cost is increased.

Secondly, the conventional elevators are driven by the induction motor and the decelerating box, but the power consumption of the induction motor is great, and the induction motor is not easy to control. In addition, the control and induction system and the driving system of the induction motor belong to different systems, so the position of the elevator cannot be controlled by the induction motor directly. Thereby, the conventional ball screw drive system is hard to control precisely and is susceptible to the control problem and induction failure.

Thirdly, the friction coefficient of the ball screw is reduced from 0.1 to 0.002, and its mechanical efficiency is improved from 30% to 95% as compared to a conventional sliding friction screw. However, the disadvantage is that the safety of the ball screw is relatively low as compared to a conventional sliding friction screw. The structure of the sliding nut of the conventional sliding friction screw is simple, it only needs to define some female threads having a trapezoid cross section in an inner surface thereof, and such a structure will have a low failure rate. Further, the sliding nut will be worn off severely before it is broken and can be detected easily, so as to prevent the potential accident caused by the sliding nut. However, the ball screw drive system is complicated in structure and comprises at least steel balls, a circulating element and a housing formed with female threads in the inner surface thereof. The ball nut may be broken even before its female threads are worn off severely (for example, the steel balls are fallen from the ball nut). Thereby, the failure of the ball screw is difficult to detect during the regular maintenance.

The present invention has arisen to mitigate and/or obviate the afore-described disadvantages.

### SUMMARY OF THE INVENTION

The primary objective of the present invention is to provide a torque motor type elevator which can save energy and is simple in structure.

The secondary objective of the present invention is to provide a torque motor type elevator which has low noise and high efficiency.

Another objective of the present invention is to provide a torque motor type elevator which is easy to control precisely.

The further objective of the present invention is to provide a torque motor type elevator which is easy to maintain.

To achieve the above-mentioned objects, the present invention provided a torque motor type elevator comprises a torque motor, a ball screw, a sliding nut and an elevator car.

The torque motor of the present invention serves to drive the load screw of the ball screw directly, so the elevator car fixed to the load nut is moved up and down, and the elevator car without needing to be equipped with a conventional accessory such as a decelerator or a counterweight, so as to reduce energy consumption of the decelerator and the counterweight. In addition, the coils wound on an annular stator base of the torque motor are provided for supplying power, so the present invention can save energy.

The torque motor of the present invention can be added with a resolver or an encoder to control the position precisely, enabling the positioning precision of the torque motor to reach 15 arc-sec. In addition, the present invention needn't to add too many position controlling systems for detecting the floor the elevator stopped at, so as to simplify the controlling system of the conventional elevator.

The ball screw of the present invention is provided for reducing the loss of energy of the elevator driving system, and the sliding nut is disposed on the ball screw to improve its safety. The sliding nut is formed with threaded teeth in an inner surface thereof, and the threaded teeth of the sliding nut are threaded with the threads of the load nut of the ball screw. Between the respective threaded teeth of the sliding nut and the threads of the load screw is a gap in such a manner that the sliding nut doesn't contact the load screw directly, and the load nut serves to Support the load of the elevator car. Thereby, the present invention can make good use of the advantages of the ball screw, for example, prevent the occurrence of energy consumption, simplify the structure and prevent the potential accidents caused by the ball screw.

The torque motor of the present invention serves to drive the load screw of the ball screw directly, so the elevator car without needing to be equipped with a conventional accessory such as a decelerator, a counterweight or a sliding wheel, thus reducing the space effectively.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view of a conventional steel cable type drive system for an elevator;

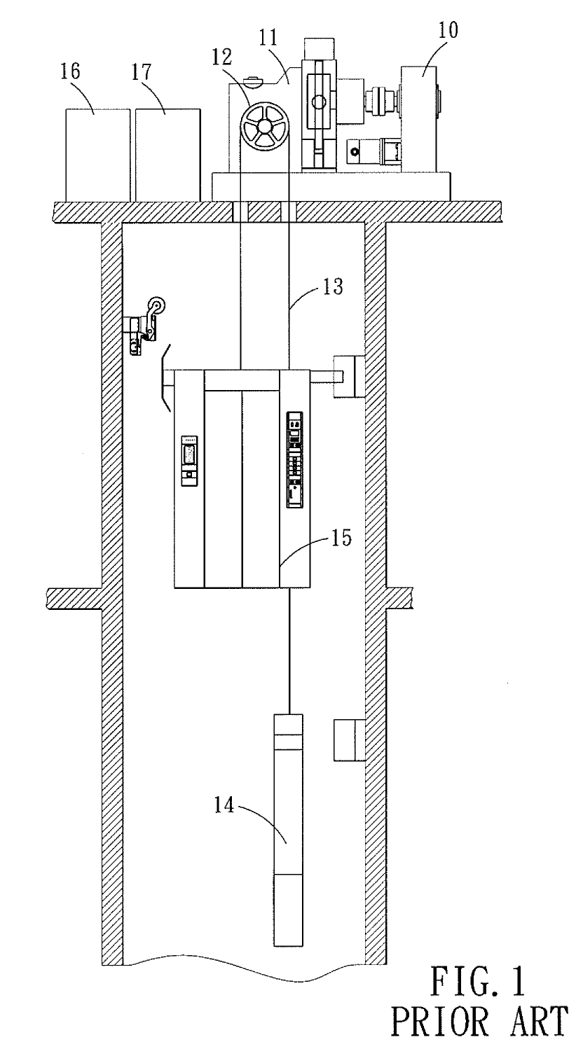

FIG. 2 is an assembly cross sectional view of a torque motor type elevator in accordance with the present invention;

FIG. 3 is a cross sectional view of a ball screw, a sliding nut and a connecting member in accordance with the torque motor type elevator of the present invention; and

FIG. 4 is a partial cross sectional view of the torque motor type elevator in accordance with the present invention.

### DETAILED DESCRIPTION OF THE PREFERRED EMBODIMENTS

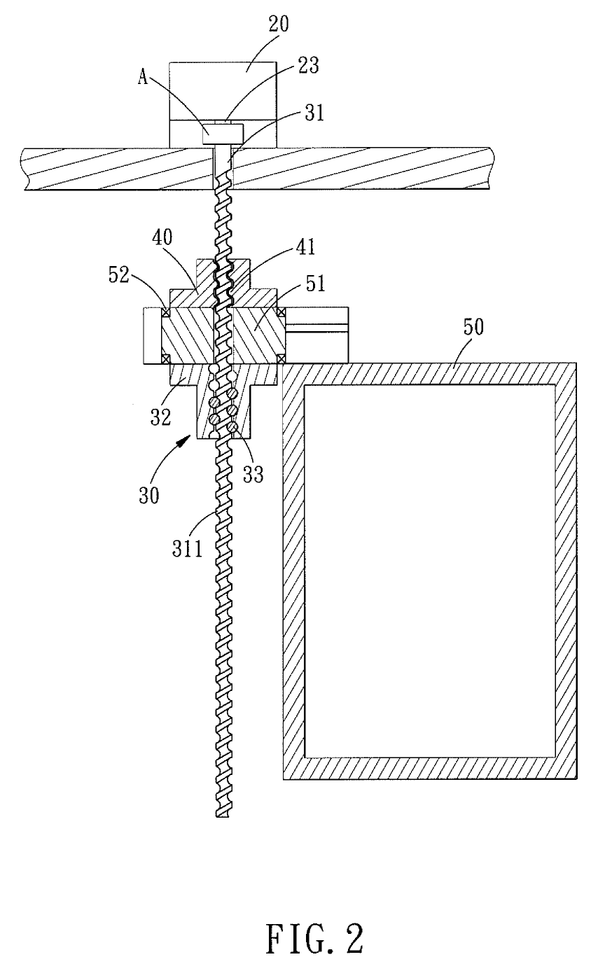

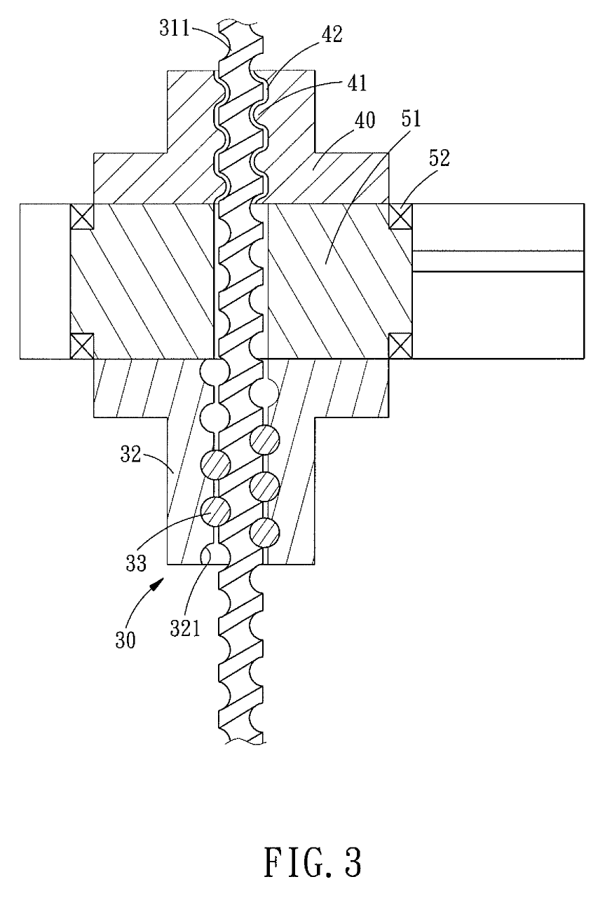

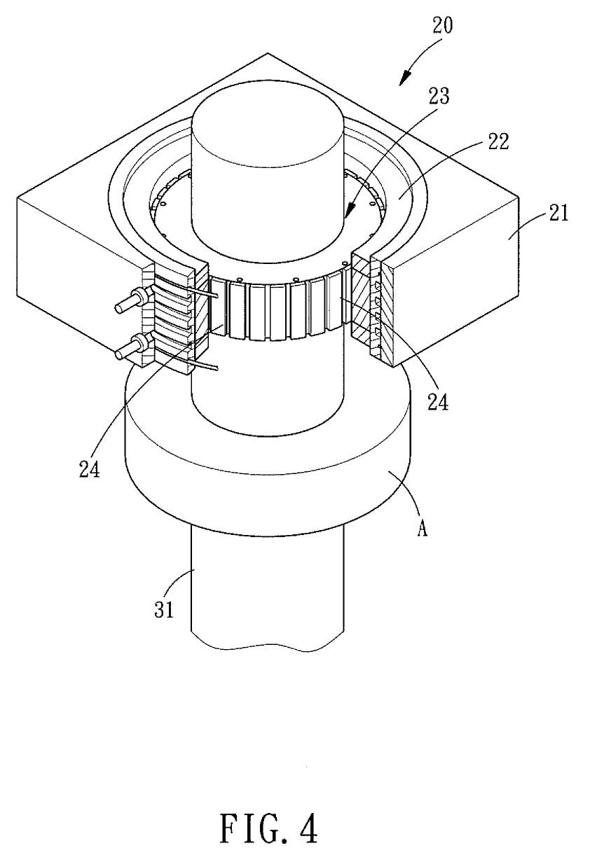

Referring to FIGS. 2-4, a torque motor type elevator in accordance with the present invention comprises a torque motor 20, a coupling A, a ball screw 30, a sliding nut 40 and an elevator car 50.

The torque motor 20 has an annular stator base 21, a plurality of coils 22, a rotor shaft 23 and a plurality of magnetic poles 24. In a center of the annular stator base 21 is defined a space for accommodation of the rotor shaft 23, and the coils 22 are wound in an inner wall of the annular stator base 21. Around an outer periphery of the rotor shaft 23 is annularly arranged the plurality of magnetic poles 24, the rotor shaft 23 is pivotally fixed in the annular stator base 21, and the magnetic poles 24 are rotated by the electromagnetic force of the coils 22.

The coupling A is mounted on one end of the rotor shaft 23 of the torque motor 20, the coupling A is an ordinary connecting apparatus and will not be described in detail.

The ball screw 30 has a load screw 31, a load nut 32 and a plurality of balls 33 (such balls generally refer to ball-shaped and column-shaped rolling elements). The load screw 31 is defined with threads 311 to be engaged with the inner sides of the balls 33, and one end of the load screw 31 is connected to the coupling A and is moved along with the rotor shaft 23 of the torque motor 20. Threads 321 of the load nut 32 are threaded with the outer sides of the balls 33, and the load nut 32 is moved up and down along with the load screw 31.

The sliding nut 40 is a hollow member formed with threaded teeth 41 in an inner surface thereof, and the threaded teeth 41 of the sliding nut 40 are threaded with the threads 311 of the load nut 31 of the ball screw 30. Between the respective threaded teeth 41 of the sliding nut 40 and the threads 311 of the load screw 31 is a gap 42 in such a manner that the sliding nut 40 doesn't contact the load screw 31 directly, and the load nut 32 serves to support the load.

The elevator car 50 is fixed to the load nut 32 of the ball screw 30 by a connecting member 51, the sliding nut 40 is also fixed to the connecting member 51, and the connecting member 51 includes bearings 52, so as to allow the elevator car 50 to move up and down and not to rotate along with the ball screw 30.

Referring further to FIGS. 2-4, the present invention has the following advantages:

With regard to the aspect of saving energy:

Firstly, the torque motor 20 of the present invention serves to drive the load screw 31 of the ball screw 30 directly, and the coils 22 wound on the annular stator base 21 of the torque motor 20 are provided for supplying power, so that the magnetic poles 24 annularly arranged around the outer periphery of the rotor shaft 23 needn't to charge. Thereby, the present invention can save the energy effectively.

Secondly, the torque motor 20 of the present invention serves to drive the load screw 31 of the ball screw 30 directly, so the elevator car 50 without needing to be equipped with a conventional accessory such as a decelerator or a counterweight, so as to reduce the loss and energy consumed by the conventional decelerator.

With respect to the aspect of simplifying the parts and reducing the space:

Firstly, the torque motor 20 of the present invention serves to drive the load screw 31 of the ball screw 30 directly, so the elevator car 50 fixed to the load nut 32 is moved up and down, and the elevator car 50 without needing to be equipped with a conventional accessory such as a decelerator or a counterweight, thus simplifying the parts and reducing the space.

Secondly, the torque motor 20 of the present invention can be added with a resolver or an encoder to control the position precisely, enabling the positioning precision of the torque motor 20 to reach 15 arc-sec. In addition, the present invention needn't to add too many position controlling systems for detecting the floor the elevator stopped at, so as to simplify the controlling system of the conventional elevator.

Concerning the aspect of low noise and high efficiency:

Firstly, the torque motor 20 of the present invention serves as a power source, and the torque motor 20 itself is rotated by the electromagnetic force of the coils 22, such that the noise of the torque motor 20 is low. Further, since the large number of the magnetic poles 24 annularly arranged around the outer periphery of the rotor shaft 23 can increase the turning force greatly, and the torque motor 20 serves to drive the load screw 31 of the ball screw 30 directly, the torque motor 20 of the present invention has a high efficiency.

Secondly, the low friction resistance of the ball screw 30 can reduce the noise, its friction coefficient is reduced from 0.1 to 0.002, and its mechanical efficiency is improved from 30% to 95% as compared to a conventional sliding friction screw, so the present invention can reduce the energy loss of the elevator driving system. Since the sliding nut 40 threaded on the ball screw 30 can improve its safety, the sliding nut 40 doesn't contact the load screw 31 directly, and plus the ball screw 30 is able to load the elevator car 50 completely, the present invention can prevent any potential unsafe condition.

With reference to the aspect of low maintenance:

Firstly, the torque motor 20 of the present invention serves as a power source, and the torque motor 20 itself is rotated by the electromagnetic force of the coils 22 in such a manner that the present invention is easy to maintain.

Secondly, the ball screw 30 of the present invention is provided for reducing the loss of energy of the elevator driving system, and the ball screw 30 is equipped with a fuel tank for self-lubricating and maintaining (such a fuel tank is a basic accessory of an ordinary ball screw and will not be described in detail), so the ball screw 30 of the present invention is easy to maintain.

It is to be noted that an elevator is such equipment that needs to have a very high safety, and needs to be checked regularly during assembly and usage to ensure its safety. For easy check, the sliding nut 40 is designed to be exposed out of the torque motor type elevator, so that the width of the gap 42 of the sliding nut 40 can be measured from the outside directly by using the gauge of different thicknesses. And the change of the width of the gap 42 can determine whether the sliding nut 40 needs to be repaired. The ball screw 30 of the present invention is made of metal material, so the ball screw 30 needn't to maintain regularly on condition that the ball screw 30 is equipped with a fuel tank and the width of the gap 42 is checked regularly.

It is also to be noted that with reference to FIGS. 2-4, the elevator car 50 is fixed to the load nut 32 of the ball screw 30 by a connecting member 51, the sliding nut 40 is also fixed to the connecting member 51, and the other inferred connecting methods are:

Firstly, the load nut 32 of the ball screw 30 is fixed to the sliding nut 40 directly, and the connecting member 51 is fixed to the load nut 32 or the sliding nut 40 directly.

Secondly, the elevator car 50 is fixed to the load nut 32 of the ball screw 30 and the sliding nut 40 respectively by different connecting members.

While we have shown and described various embodiments in accordance with the present invention, it should be clear to those skilled in the art that further embodiments may be made without departing from the scope of the present invention.

What is claimed is:

1. A torque motor type elevator, comprising: a torque motor, a ball screw, a sliding nut and an elevator car; wherein:
the torque motor has a rotor shaft rotated by electromagnetic forces;
the ball screw has a load screw, a load nut and a plurality of balls, one end of the load screw is moved along with the rotor shaft of the torque motor, and the load nut is disposed on the load screw;
the sliding nut is a hollow member formed with threaded teeth in an inner surface thereof, the threaded teeth of the sliding nut are threaded with threads of the load nut of the ball screw, between the respective threaded teeth of the sliding nut and the threads of the load screw is a gap; and
the elevator car is fixed to the load nut of the ball screw by a connecting member and is moved up and down along with the load nut of the ball screw.

2. The torque motor type elevator as claimed in claim 1, wherein the torque motor has an annular stator base, a plurality of coils, a rotor shaft and a plurality of magnetic poles, in a center of the annular stator base is defined a space for accommodation of the rotor shaft, the coils are wound in an inner wall of the annular stator base, around an outer periphery of the rotor shaft is annularly arranged the plurality of magnetic poles, the rotor shaft is pivotally fixed in the annular stator base, and the magnetic poles are rotated by the electromagnetic force of the coils.

3. The torque motor type elevator as claimed in claim 1, wherein the elevator further including a coupling mounted on one end of the rotor shaft of the torque motor, and one end of the load screw is connected to the coupling and is moved along with the rotor shaft of the torque motor.

4. The torque motor type elevator as claimed in claim 1, wherein the sliding nut is also fixed to the connecting member, and the connecting member includes bearings, so as to permit the elevator car to move up and down and not to rotate along with the ball screw.

5. The torque motor type elevator as claimed in claim 1, wherein the load nut of the ball screw is fixed to the sliding nut directly.

6. The torque motor type elevator as claimed in claim 1, wherein the elevator car is fixed to the load nut of the ball screw and the sliding nut respectively by different connecting members.
